(19) United States
(12) Patent Application Publication
(10) Pub. No.: US 2016/0334016 A1
(43) Pub. Date: Nov. 17, 2016

(54) CYLINDER-HEAD GASKET, AND A SEALING SYSTEM COMPRISING SUCH A GASKET

(71) Applicant: ElringKlinger AG, Dettingen (DE)

(72) Inventor: Matthias Braun, Reutlingen (DE)

(73) Assignee: ElringKlinger AG

(21) Appl. No.: 15/220,781

(22) Filed: Jul. 27, 2016

Related U.S. Application Data
(63) Continuation of application No. PCT/EP2014/078697, filed on Dec. 19, 2014.

(30) Foreign Application Priority Data
Jan. 28, 2014 (DE) 10 2014 100 948.7

(51) Int. Cl. F16J 15/08

(52) U.S. Cl. CPC F16J 15/0825; F16J 2015/085

(57) ABSTRACT

A cylinder-head gasket is provided having a plurality of combustion-chamber openings, fluid-passage openings, screw holes, and at least a first functional layer and a carrier layer. The functional layer has combustion-chamber-sealing beads surrounding the combustion-chamber openings, and, on the side of the combustion-chamber-sealing beads directed away from the combustion-chamber openings, at a spacing from said beads, at least one fluid-sealing bead formed as a half-bead and having a first bead foot to be pressed against the carrier layer, and a second bead foot spaced apart from the first bead foot by the bead width. The carrier layer has, on its side directed towards the first functional layer, at least one depression extending along the first bead foot and of such a width that only a strip-like region of the first functional layer lies over the depression and contains only the first bead foot and at most, half the bead width.

### CROSS REFERENCE TO RELATED APPLICATIONS

This application is a continuation of international application No. PCT/EP2014/078697 filed on Dec. 19, 2014, and claims the benefit of German patent application No. 10 2014 100 948.7 filed Jan. 28, 2014, both of which are incorporated herein by reference in their entireties and for all purposes.

### BACKGROUND OF THE INVENTION

The invention relates to a cylinder-head gasket having an elongate, multi-layered, metal seal plate, which comprises a plurality of combustion-chamber openings, fluid-passage openings, and screw holes for the passage of cylinder-head screws, and also a carrier layer and at least one functional layer, which is provided with combustion-chamber-sealing beads, which surround the combustion-chamber openings, and with at least one fluid-sealing bead, which is formed as a half-bead and is arranged (in a plan view of the seal plate) on that side of the combustion-chamber-sealing beads which is directed away from the combustion-chamber openings, at a spacing from said beads, and also has a first bead foot, which is to be pressed against the carrier layer, and a second bead foot.

In the case of a cylinder-head gasket of this type, the fluid-passage openings are through-openings for cooling water and/or engine oil, and a functional layer is understood by a person skilled in the art of seals to be a sheet-metal layer in which beads having resilient properties are impressed (a functional layer usually consists of a sheet spring steel), whereas the carrier layer does not normally require any resilient properties, is substantially flat, but can also be contoured at one or more points as appropriate, and has a greater material thickness than a functional layer, and the half-beads forming the fluid-sealing beads are in each case endless and closed on themselves (in a plan view of the seal plate).

Sealing beads provided in functional layers of cylinder-head gaskets must have permanently resilient properties, i.e. the height of a sealing bead of this type must always be able to resiliently reduce as a result of pressing forces acting on said sealing bead, such that the bead height resiliently increases again when the pressing forces diminish; this is necessary for the following reasons, so that the sealing bead can perform its sealing function in a durable manner: The engine components (engine block and cylinder head), especially the cylinder head, cannot be considered as absolutely rigid components, and the cylinder head is also only connected to the engine block at certain points, specifically by the cylinder-head screws, such that the pressing forces acting on the cylinder-head gasket clamped between the cylinder head and engine block are introduced into the cylinder-head gasket primarily locally (specifically into the regions where the cylinder-head screws are disposed). Consequently, without any particular measures, the sealing face of the assembled cylinder head directed towards the cylinder-head gasket is no longer flat or no longer lies in one plane on account of distortions of the cylinder head, and the pressing forces acting on the cylinder-head gasket diminish with increasing distances from the cylinder-head screws—for this reason alone, the seal gap between the engine block and cylinder head to be sealed by the cylinder-head gasket therefore does not have the same width or height everywhere. During engine operation, there are additionally local dynamic changes to the width of the seal gap, said changes being caused by the cyclically changing gas pressures of the gases ignited in the cylinders, which gas pressures act locally on the cylinder head, but also by quasi-static seal gap changes, which are caused as a result of the fact that said engine components are subjected to thermal expansions relative to one another, and also to locally different thermal expansions.

So that combustion-chamber-sealing beads surrounding combustion-chamber openings are not excessively flattened by functional layers of the cylinder-head gaskets during engine assembly, or during engine operation, and might thus lose their resilient properties completely or partially or might even be exposed to the risk of cracks appearing in a functional layer in a bead region during the course of engine operation, it is usual to provide, in cylinder-head gaskets, deformation limiters (referred to hereinafter as stoppers), which are associated with the combustion-chamber-sealing beads and are disposed directly adjacently to these beads. In addition, cylinder-head gaskets often comprise what are known as backland stoppers, with the aid of which cylinder-head distortions are to be counteracted and which (in a plan view of the cylinder-head gasket) are arranged on that side of the combustion-chamber-sealing beads which is directed away from the combustion-chamber openings and at spacings from said beads, in particular in the longitudinal end regions of a cylinder-head gasket for a multi-cylinder engine.

Since, following the installation of a cylinder-head gasket, a pressed sealing bead of a functional layer must exert considerable restoring forces so as to be able to ensure a sufficient seal during engine operation, the sealing beads attempt to locally widen the seal gap between cylinder head and engine block in the bead regions; this tendency exists particularly in those regions of the cylinder-head gasket in which a plurality of sealing beads extend adjacently to one another (in a plan view of the cylinder-head gasket), as is the case in particular in the vicinity of cylinder-head screws—there, sealing and/or supporting beads often extend directly adjacent to one another, in particular both a fluid-sealing bead for cooling water and a fluid-sealing bead for engine oil.

Because, as already mentioned, the forces for the clamping of the cylinder head, engine block and cylinder-head gasket are introduced only locally into the sealing system, specifically by the cylinder-head screws, it is sought, for reasons yet to be discussed, for the layers of the cylinder-head gasket and the engine block to be pressed “en bloc” in the regions of the cylinder head screws during the course of the engine assembly as said cylinder head screws are tightened, i.e. for the layers of the cylinder-head gasket and also the sealing faces directed theretowards of the cylinder head and engine block to be pressed against one another without gaps in the regions of the cylinder-head screws and for the cylinder-head gasket to be pressed flat there. Among modern engines, however, there are those in which the forces applied by the cylinder-head screws are insufficient to be able to draw the cylinder head en bloc in all regions directly adjacent to the cylinder-head screws, and therefore, in these regions, a small gap remains between the cylinder head and the cylinder-head gasket, but possibly also between the latter and the engine block, and consequently the cylinder-head gasket and particularly the cylinder head are not pressed flat there against one another. This can lead, during engine operation, to an increase of the fluctuations over time of the seal gap width and to comparatively greater relative movements between the cylinder head and engine block (so-called sliding movements in the seal gap plane), thus potentially resulting in the risk of formation of cracks in the functional layers in the bead regions thereof and an increased wear at the regions of the sealing system to be sealed with respect to one another. The reasons why, in some screw regions, the desired flat pressing of the cylinder-head gasket between the cylinder head and the engine block cannot be achieved with the cylinder head screws are as follows (individually or in combination): restoring forces of sealing beads counteracting the screw forces, particularly when the cylinder-head gasket has a plurality of sealing beads in the vicinity of a cylinder-head screw—this is particularly the case when the cylinder head, in the vicinity of cylinder-head screws, is also supported by the combustion-chamber-sealing beads (what are known as combustion-chamber stoppers). If the cylinder-head gasket, besides combustion-chamber stoppers, also has backland stoppers supporting the cylinder head, sealing beads present in some screw regions as well as the combustion-chamber stoppers and the backland stoppers counteract a flat pressing of the cylinder-head gasket between the cylinder head and the engine block in said regions.

It could be envisaged to achieve a flat pressing of the cylinder-head gasket between the cylinder head and engine block in the aforementioned screw regions by reducing the spring force of the sealing beads, in particular of the fluid-sealing bead or beads, by means of an appropriate bead design; this, however, generally rules itself out, because, due to the above-described dynamic and quasi-static expansions of the seal gap, which are unavoidable during engine operation, relatively high bead forces are necessary so that the sealing bead or beads can always reliably perform its/their sealing function (a reduction of the bead force only in the screw regions by varying the height along the bead during production of said bead is not generally recommended for production-related reasons).

The following is to be noted: When assembling the cylinder head, the cylinder-head gasket, once the cylinder-head screws have been properly tightened, is acted on by the highest screw forces, i.e. pressing forces, however these are significantly lower after the first start-up of the engine (for example approximately 15% lower when the engine is warm and approximately 20% to 35% lower when the engine is cold), more specifically on account of settling processes at the engine components and a certain elongation of the cylinder-head screws when the engine is started up for the first time. This must be taken into account by accordingly higher screw forces when assembling the cylinder head so that the sealing beads can perform their sealing function in a lasting manner during engine operation; as a result of these higher screw forces applied during the assembly of the cylinder head, the fluid-sealing beads were previously deformed (flattened) to a greater extent, however, than is the case during engine operation, and it has been found that, as a result of this stronger flattening of the sealing beads, the durability thereof is reduced. Although this can be counteracted by providing the cylinder-head gasket with backland stoppers in order to limit the flattening of the fluid-sealing beads during the assembly of the cylinder head, backland stoppers increase the production costs of a cylinder-head gasket, and especially in modern engines it is often problematic or even impossible, due to space reasons, to accommodate backland stoppers at those locations in a cylinder-head gasket where said stoppers would be required in order to prevent excessive flattening of the fluid-sealing beads during the assembly of the cylinder head.

Lastly, reference is also made to the following: As is clear from the foregoing, without a height profiling of the fluid-sealing beads, which is problematic, unnecessarily high or even disadvantageous excessive bead forces are present in the mentioned screw regions, which forces take up some of the screw forces required imperatively at other locations of the engine components or cylinder-head gasket in order to reliably provide a seal there with respect to high media pressures, in particular of the combustion gases, but also of the pressurized engine oil.

### SUMMARY OF THE INVENTION

The object of the invention was to design a cylinder-head gasket of the type mentioned in the introduction such that the above-described problems of the prior art are wholly or partially remedied or at least minimized.

This can be achieved advantageously in that the carrier layer of the cylinder-head gasket has, at least on its first layer side directed towards the at least one, first functional layer, at least in some regions of said first layer side adjacent to screw holes, at least one elongate and shallow depression extending along the first bead foot, said depression being of such a width that (in a plan view of the seal plate) only a strip-like region of the first functional layer lies above the depression and contains only the first bead foot of the half-bead, but not the second bead foot.

In particularly advantageous embodiments of the invention, the carrier layer comprises, on its first layer side directed towards the at least one, first functional layer, a depression or depressions of the aforementioned type only in those regions of the seal plate of said carrier layer close to a screw hole in which one or more beads, in particular one or more fluid-sealing beads, extends/extend in the immediate vicinity of the screw hole.

In the case of the cylinder-head gasket proposed by the present invention, the fluid-sealing bead is usually an endless half-bead, that is to say a half-bead that is closed on itself, whereas the depression provided in the carrier layer and extending along the first bead foot is preferably likewise endless and (in a plan view of the seal plate) is closed on itself, but can also be formed discontinuously and for example can be formed of depression portions which follow one another in succession in the longitudinal direction of the first bead foot and which are arranged particularly in the vicinity of screw holes of the seal plate—the fact that the above object can also be achieved by an implementation of this type is evident from the above description of the problems which might be encountered with known cylinder-head gaskets of the type mentioned in the introduction.

Since the first bead foot (at least in some regions) engages in the depression, the latter (at least in some regions) causes a reduction of the effective bead height and therefore of the bead force, more specifically preferably at least in the vicinity of screw holes, whereby a flat pressing of the cylinder-head gasket between the cylinder head and engine block can be achieved in the regions close to the screws and therefore it might be possible to dispense with backland stoppers when these are intended solely for the purpose of preventing excessive deformations of the fluid-sealing beads during the course of the installation of the seal.

For engines of which the cylinder head must be supported by backland stoppers, a cylinder-head gasket according to the invention is embodied such that, when the cylinder-head gasket has been installed, the elements of the seal plate are clamped en bloc in the regions of the combustion-chamber stoppers and the cylinder-head-supporting elements, that is to say the backland stoppers, between the cylinder head and the engine block. Due to the reduction of the forces exerted by the half-bead and acting primarily on the cylinder head, in particular in the vicinity of screw holes or cylinder-head screws, but also due to the possible omission, where appropriate, of one or more backland stoppers, there is an advantageous shifting of the screw forces to the regions of the sealing system surrounding the combustion chambers; with the cylinder-head gaskets proposed by the present invention, it is also possible in many cases to reduce the height of the combustion-chamber stoppers and, in some circumstances, also of the (as yet unpressed) combustion-chamber-sealing beads compared with known cylinder-head gaskets of the type mentioned in the introduction in order to achieve a desired advantageous distribution of the forces applied by the cylinder-head screws via the cylinder-head gasket, in particular the distribution of the screw forces over, on the one hand, the regions of the sealing system surrounding the combustion chambers and, on the other hand, what is known as the backland region of the cylinder-head gasket.

Since any cylinder-head gasket is constructed for a rather specific engine of which the properties, inclusive of the locally differing rigidities of the cylinder head and engine block and also the locally differing component temperatures for all engine operating states, are made known to the seal fabricator by the engine manufacturer, finite element calculations provided on this basis form part of the conventional aids used by a fabricator of cylinder-head gaskets, which is why said fabricator can readily define the depth of the depression to be formed in the carrier layer by means of a finite element calculation, such that, at any point of the half-bead for any operating state, a pressing of the bead sufficient for the sealing functions is provided, but the bead force is reduced to a minimum that is still sufficient for the sealing capability of the bead. It should be noted at this juncture that it may be recommended, in order to achieve the aforementioned objectives, to provide the depression with an appropriate depth profile, i.e. to vary the depth of said depression along the half-bead accordingly, which is easily possible in terms of fabrication, particularly when the depression is an impression in the carrier layer.

It should also be emphasized that a cylinder-head gasket according to the invention can be configured advantageously such that, when the cylinder-head gasket is installed, the half-bead thereof is in what is known as a shunt pressure path (for example also on account of combustion-chamber stoppers of corresponding height), more specifically even with omission of a backland stopper serving to protect the half-bead or with use of backland stoppers which are of reduced height compared with the prior art and which serve to support the cylinder head, wherein it should be noted at this juncture that the durability of a sealing bead in a shunt pressure path is generally much greater than that of a sealing bead in what is known as a main pressure path.

The following is noted with regard to the definition of a main pressure path and shunt pressure path.

A bead is always in a shunt pressure path when it is associated with a stopper acting as a deformation limiter, i.e. a stopper having a height, effective for the deformation limitation, of greater than zero. A stopper can be formed by a material thickening or a groove for engagement of a bead crest or a bead foot.

With no action of a stopper, a bead is in a main pressure path.

Although the depression can have any cross-sectional shape in principle, for example a rectangular cross-section, embodiments in which the depression has a cross-section in the form of a rounded shallow trough of which the deepest point lies preferably in the middle between the edges of the trough are preferred for reasons of fabrication. In preferred embodiments of the cylinder-head gasket according to the invention, the first bead foot lies approximately above a longitudinal central region of the depression (in a plan view of the pressed seal plate), that is to say in a longitudinal region of the depression lying approximately in the middle between the edges of the depression.

Particularly advantageous embodiments of the cylinder-head gasket according to the invention are characterized by one or by more of the following features: The depth of the region of the depression opposite the first bead foot of the half-bead, averaged along the depression (due to a possible depth profile of the depression), is approximately equal to 4 to 30%, preferably equal to 10 to 25% of the height of the unpressed half-bead, that is to say the bead height when the cylinder-head gasket is not yet installed; the height of the unpressed half-bead is 150 to 250 μm, preferably 180 to 220 μm, however this is relevant only for a number of passenger vehicle engines and is not relevant for large engines, in particular for large utility vehicle engines; the depth of the region of the depression opposite the first bead foot of the half-bead, averaged along the depression, is approximately 10 to 60 μm, preferably 10 to 35 μm; if the depression has a depth profile, the depth of the depression in the region close to the screws is preferably approximately 60 μm, and in regions remote from the screws is preferably less than 10 μm.

In the case of the above values specified for the depth of the depression compared with the bead height, the range 4 to 30% relates to a depression without depth profile, and the range 10 to 25% relates to a depression with depth profile.

Where reference is made above and hereinafter to the depth of the depression, this is understood to mean at any point, in particular, the maximum depth of the depression.

In the case of embodiments of the cylinder-head gasket proposed by the invention having a depression impressed in the carrier layer that are preferred for reasons of fabrication, it is advantageous when the carrier layer has, on its first layer side directed towards the at least one, i.e. the first, functional layer, on both sides of said depression, a bulge extending along the depression, said bulge protruding over the first layer side, the material volume of the two bulges being, in total, in particular approximately the same as the volume of the impressed depression, that is to say the material volume of the two bulges being, in total, approximately the same as the volume of the material displaced from the carrier layer as the depression is impressed into said carrier layer. In such embodiments, the depth of the depression effective when the cylinder-head gasket is installed is equal to the spacing of the base of the depression from the crests of the bulges (in section through the carrier layer perpendicularly to the longitudinal direction of the depression). As will become evident from the following, the cylinder-head gasket can be embodied such that the bulges can limit the deformation, that is to say the flattening, of the half-bead when the cylinder-head gasket is installed and during engine operation to a certain extent, this being determinable by the embossing tool used for the production of the depression, by means of which tool the bulge cross-section can be defined in terms of shape, height and width, even if the material volume of the bulge is specified by the cross-section of the depression to be embossed.

In preferred embodiments of the cylinder-head gasket according to the invention, the carrier layer is arranged between functional layers and then has, on both of its sides, depressions for first bead feet of half-beads provided in the functional layers. Here, it is generally advantageous, on account of the openings communicating with each other provided in the cylinder head and in the engine block, to form the seal plate of the cylinder-head gasket, at least in the regions of the half-beads, at least substantially mirror-symmetrically with respect to a central plane of the carrier layer extending in the carrier layer. Here, it may have to be taken into consideration that the carrier layer outside the half-bead regions can be configured, for example by contouring, such that the seal plate may be formed so as not to be mirror-symmetrical everywhere with respect to said central plane. With regard to the mirror-symmetrical design of the seal plate, it should be noted that this does not necessarily have to be the case in respect of bead heights and trough depths as well.

As already mentioned, in the case of a cylinder-head gasket according to the invention, a depression formed in the carrier layer can have a depth that changes in the longitudinal direction of the depression, that is to say may have a depth profile or may even be formed discontinuously (for example can be formed by depression portions arranged at spacings from one another in the longitudinal direction of the depression). For this case, particularly advantageous implementations are recommended, in which the depression, along the first bead foot, has a depth that changes in such a way that screw holes (in the seal plate) of adjacent portions of the depression have a greater depth than depression portions adjacent to seal plate regions disposed between adjacent screw holes, also including the case in which no depression is provided in the vicinity of seal plate regions disposed between adjacent screw holes or is provided only in some regions. For such preferred embodiments, it is thus true that the depression has a comparatively large depth in regions close to screws (on account of the bead forces that would otherwise be too high there), whereas the depression has a shorter depth in the regions remote from the screws (due to the bead forces that are reduced there anyway), if a depression is provided there at all. In the knowledge of the present invention, the locally differing optimal depths of the depression can be easily determined for all operating states of the engine by means of a known finite element calculation, which is routine in the construction of cylinder-head gaskets.

It is generally true for preferred embodiments of the cylinder-head gasket according to the invention that the seal plate thereof is embodied in such a way that, when the cylinder-head gasket is installed, the carrier layer and the at least one functional layer (together with the cylinder head and the engine block) are clamped en bloc in the screw hole regions, that is to say bear there against one another.

As already mentioned, the invention also relates to a sealing system comprising at least one cylinder head, an engine block, cylinder-head screws, and a cylinder-head gasket clamped between the cylinder head and engine block, having one or more of the features proposed by the present invention.

Here, recommended embodiments of such a sealing system are those in which the depth of the at least one depression is matched to the design and spring hardness of the at least one half-bead and the rigidities and also the temperature expansion coefficients of the cylinder head, engine block and cylinder-head screws (preferably on the basis of a finite element calculation) in such a way that the half-bead, as the cylinder-head gasket is clamped, is not excessively flattened in the sense of the durability of the half-bead (no deterioration of the spring forces and avoidance of the risk of crack formation), and, following installation of the seal and during engine operation, the bead feet of the half-bead are pressed all over in strip-like bearing regions by means of a force sufficient for the sealing capability of said half-bead, against the carrier layer and the cylinder head or the engine block (where appropriate against one or more further seal layers between the functional layer or the functional layers and the cylinder head and/or the engine block).

Further features, advantages and details of the invention will emerge from the accompanying illustration in the drawings of preferred embodiments of the invention and/or from the following description of these drawings; in which:

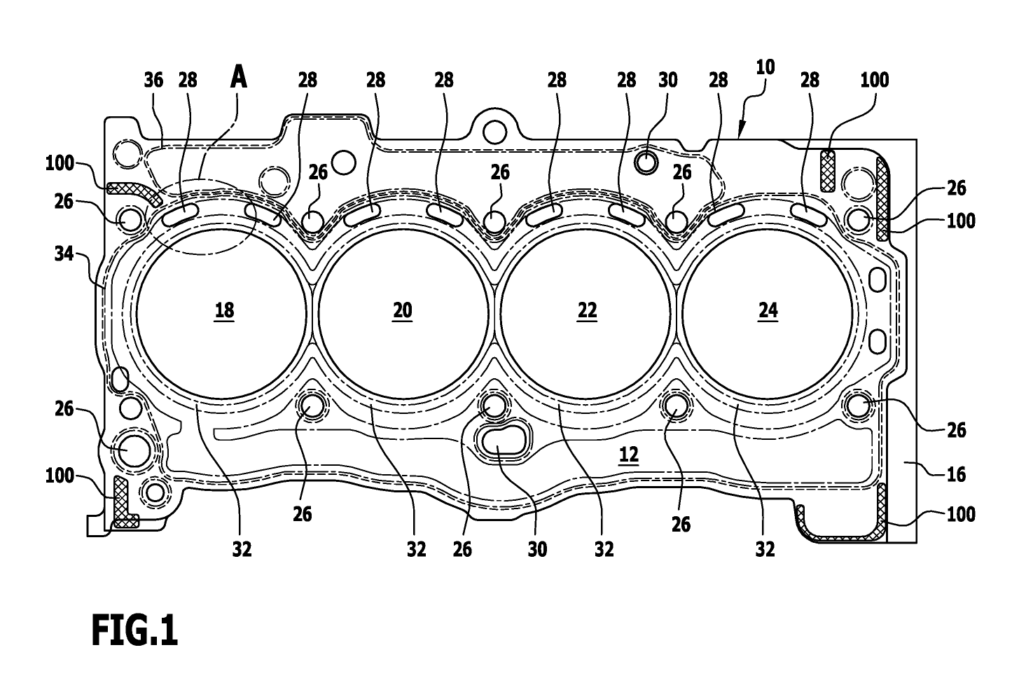

FIG. 1: shows a plan view of an embodiment of a cylinder-head gasket according to the invention, which, however, has four combustion-chamber openings, merely by way of example, that is to say is intended for a four-cylinder engine or a cylinder bank of a V-8 engine;

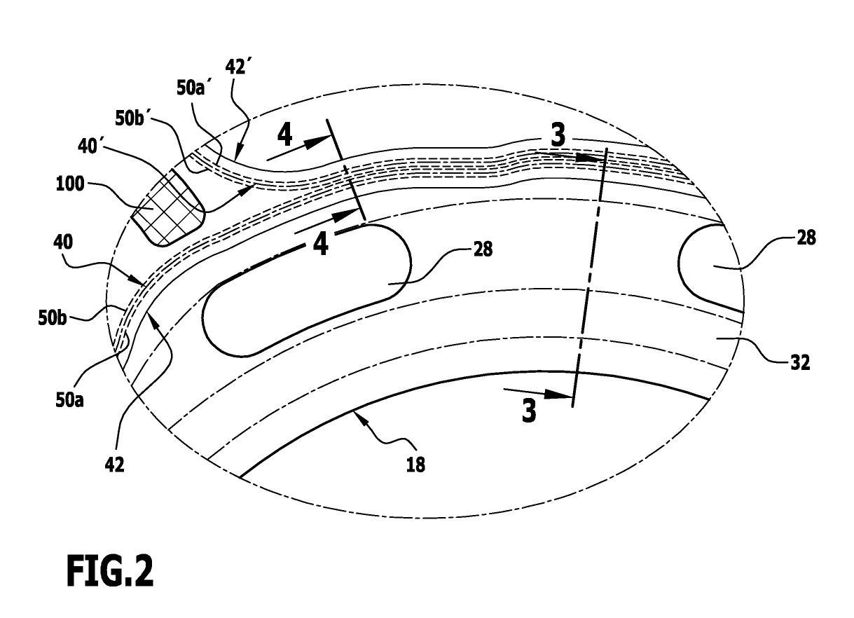

FIG. 2: shows an enlarged illustration of the detail “A” from FIG. 1;

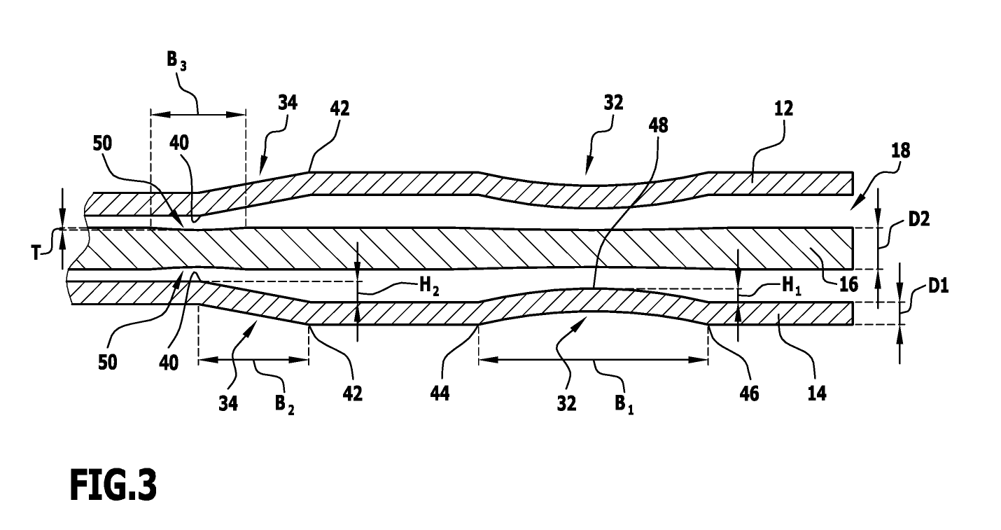

FIG. 3: shows a section through a region of this cylinder-head gasket, more specifically a section along the line 3-3 from FIG. 2, this section showing the cylinder-head gasket in the non-pressed state, any combustion-chamber stoppers possibly present not being illustrated;

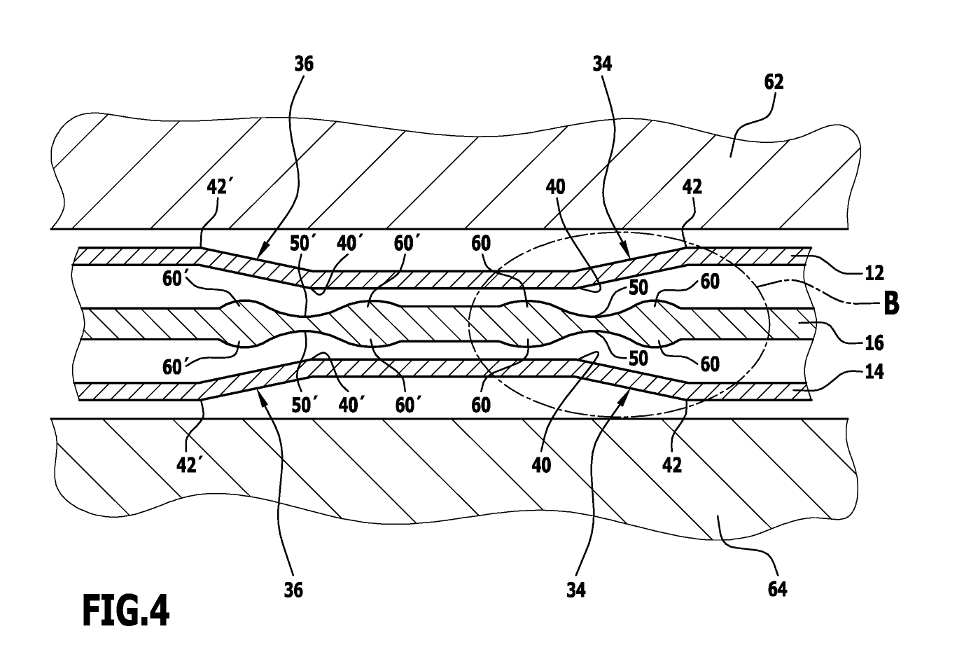

FIG. 4: shows a section through another region of this cylinder-head gasket, more specifically a section along the line 4-4 in FIG. 2, in which the cylinder-head gasket of adjacent regions of the cylinder head and of the engine block have also been indicated and the sealing system has been illustrated in the as yet unpressed state (in addition, changes to the material thickness of the carrier layer have been heavily exaggerated compared with reality);

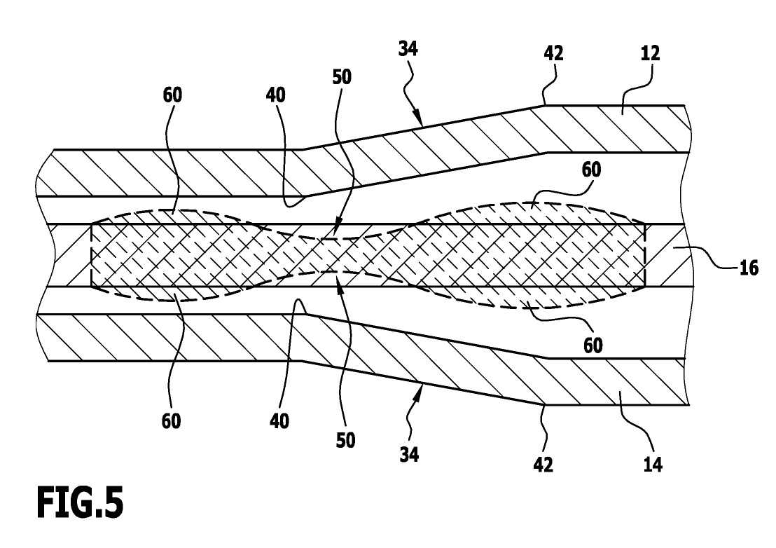

FIG. 5: shows the detail “B” from FIG. 4 in an enlarged illustration before and after depressions have been impressed into the carrier layer;

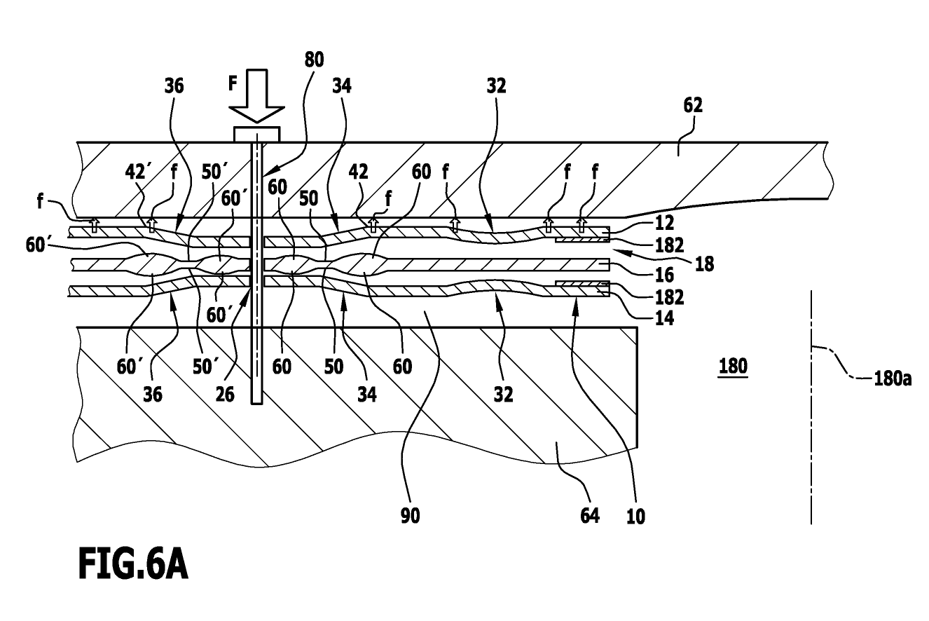

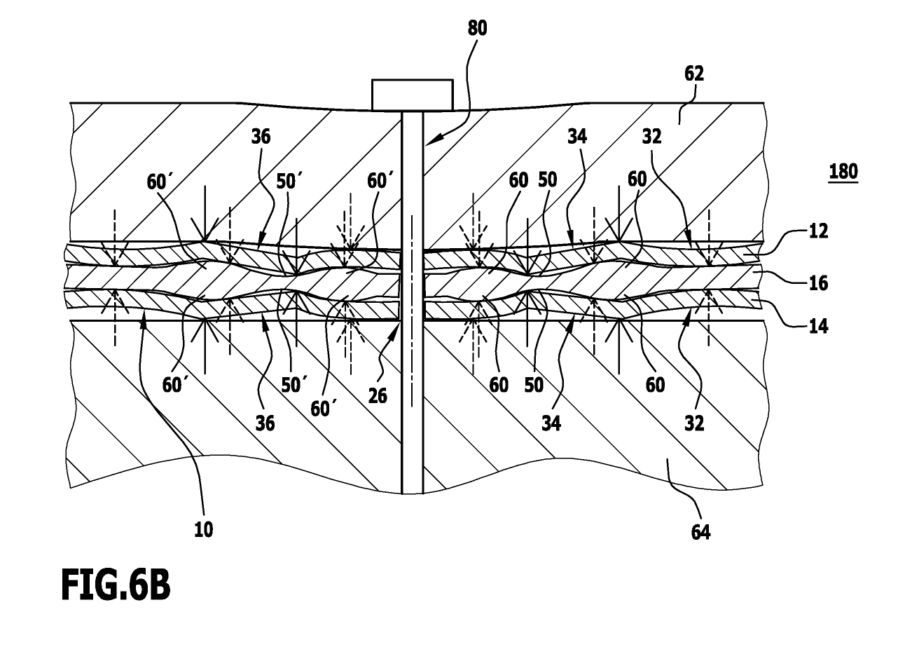

FIG. 6A: shows an illustration similar to that in FIG. 4, in which, however, larger regions of the cylinder-head gasket and of the adjacent engine components (cylinder head and engine block) have been indicated; FIG. 6A additionally shows a cylinder-head screw and combustion-chamber stopper;

FIG. 6B: shows a somewhat schematic detail from FIG. 6A following the tightening of the cylinder-head screws.

### DETAILED DESCRIPTION OF THE INVENTION

FIG. 1 shows a plan view, in which some details are absent, of a multi-layered, at least substantially metallic cylinder-head gasket, of which the seal plate, which is designated by 10 in FIG. 1, has three seal layers according to FIG. 3, specifically an upper and a lower functional layer 12 and 14 and a carrier layer 16 arranged therebetween. FIG. 1 thus shows, in particular, a plan view of the upper functional layer 12, but also shows some details of the carrier layer 16 yet to be described, said carrier layer protruding beyond the functional layers 12 and 14 in regions, said functional layers preferably being congruent.

Four combustion-chamber openings 18, 20, 22 and 24 are formed in the seal plate 10, but in addition also further through-openings, such as screw holes 26 for the passage of cylinder-head screws, water holes 28 for the passage of cooling water, and also oil-passage openings 30 (only illustrated in part)—further passage openings in the seal plate 10, however, are additionally illustrated in FIG. 1, but are insignificant for the present invention and therefore do not need to be described here. At least most of these passage openings in the seal plate 10 are formed by openings produced in the seal layers 12, 14 and 16 and arranged congruently above one another.

For each of the combustion-chamber openings 18 to 24, a combustion-chamber-sealing bead 32 embodied as a full bead is formed in each of the functional layers 12, 14 (see also FIG. 3), wherein, in each of the functional layers 12, 14, the combustion-chamber-sealing beads 32 transition into one another in the web regions between adjacent combustion-chamber openings so that the combustion-chamber-sealing beads surround the combustion-chamber openings in a spectacles-like manner.

The region of the cylinder-head gasket flooded with cooling water on account of the water holes 28, said cylinder-head gasket lying between the combustion-chamber-sealing beads 32 and what is known as a water bead enclosing the totality of all combustion-chamber openings and water holes, is sealed on the one hand by the combustion-chamber-sealing beads 32 and on the other hand by half-beads 34 in the two functional layers 12 and 24, which half-beads are in particular arranged congruently above one another, wherein the half-beads 34 visible in FIGS. 3 and 4 as well form the above-mentioned water beads.

The region or those regions of the seal plate 10 that contains/contain one or more oil-passage openings 30 is/are surrounded and sealed in the engine by what are known as oil beads, which are formed in the functional layers 12, 14, wherein just one of these regions will be discussed in greater detail hereinafter, which region is arranged at the top in FIG. 1 and is surrounded and sealed in the engine by oil beads, which are formed in the functional layers 12, 14, are arranged congruently above one another and are embodied as half-beads 36—the half-beads 36 are also illustrated in FIG. 4.

As can be clearly seen in FIG. 1, the half-beads 34 and 36 extend directly adjacently (in a plan view of the seal plate 10) in the direct vicinity of some of the screw holes 26, specifically beside the second, third and fourth screw hole 26 in the upper row of screw holes 26 according to FIG. 1, so that, when the cylinder-head gasket is installed, the spring forces (restoring forces) of a plurality of fluid-sealing beads, specifically the half-beads 34 and 36, counteract the clamping and pressing forces applied by the cylinder-head screws in the direct vicinity of these three screw holes 26 and thus lead to the problems discussed further above.

A known deformation-limiting device for the combustion-chamber-sealing beads 32 has been omitted from FIG. 3 for the sake of simplicity; a deformation-limiting device is shown, however, in FIG. 6A, which is yet to be described.

As already mentioned, FIG. 3 shows the seal plate of the cylinder-head gasket in the unpressed state, i.e. before the installation of the cylinder-head gasket, and the seal layers 12, 14 and 16 have been shown at vertical distances from one another according to FIG. 3 for better representation, although they bear against one another in the state in which the cylinder-head gasket is supplied, since in a multi-layered seal plate the seal layers thereof are interconnected, for example by riveting or spot-welding.

In most applications of a cylinder-head gasket according to the invention, the carrier layer will have a greater sheet thickness than the functional layer or the functional layers, i.e. the material thickness D1 of the functional layer 14 indicated in FIG. 3 will be smaller then the material thickness D2 of the carrier layer 16 indicated in FIG. 3, and in the embodiment illustrated in FIG. 3 both functional layers 12, 14 have the same material thickness D1. Furthermore, in preferred embodiments of the cylinder-head gasket according to the invention the at least one functional layer, i.e. in the embodiment according to FIG. 3 both the functional layer 12 and the functional layer 14, consists of a sheet spring steel, which has resilient properties even at the operating temperatures of the cylinder-head gasket, whereas the carrier layer 16 is preferably produced from a sheet steel, which is more ductile and thus more easily formable than a sheet spring steel.

As can be seen from FIG. 3, the half-bead 34 of the at least one functional layer of a cylinder-head gasket according to the invention protrudes in the direction of the carrier layer 16, and the same is also true in preferred embodiments for the combustion-chamber-sealing bead 32 embodied as a full bead—here, the protrusion is in relation to the level of the functional layer between the two beads 32 and 34. It should be noted at this juncture, with regard to FIGS. 1, 2 and 4, that the foregoing is also true for the half-bead 36.

The half-bead 34 (the same is also true for the half-bead 36) of the at least one functional layer 12 or 14 has a first bead foot 40 turned towards the carrier layer 16 and a second bead foot 42 averted from the first bead foot and turned towards the adjacent engine component (cylinder head or engine block) when the cylinder-head gasket is installed, whereas in preferred embodiments of the cylinder-head gasket according to the invention, bead feet 44 and 46 of the combustion-chamber-sealing bead 32 formed as a full bead are turned towards the adjacent engine component when the cylinder-head gasket is installed and a bead crest 48 faces towards the combustion-chamber-sealing bead 32 of the carrier layer 16. In FIG. 3 the width of the combustion-chamber-sealing bead 32 to be measured between the bead feet 44 and 46 is designated by B₁, the height of the combustion-chamber-sealing bead 32 is designated by H₁, the width of the half-bead 34 to be measured between the bead feet 40 and 42 is designated by B₂, and the height of this half-bead is designated by H₂. B₁ is usually in the order of a few millimeters, for example 2 to 3 mm, H₁ approximately 0.1 to 0.2 mm, for example approximately 0.15 mm, B₂ approximately 1.0 to 1.5 mm, for example 1.2 mm, and H₂ approximately 0.15 to approximately 0.25 mm, for example approximately 0.2 mm.

For a pressing, at least in regions, of the first bead foot 40 of the half-bead 34 of the at least one functional layer 12 or 14 into the carrier layer 16 (when the cylinder-head gasket is installed, that is to say pressed), the carrier layer 16, on its side turned towards the half-bead 34 in question, has a shallow, channel-like or groove-like depression 50, of which the width in FIG. 3 has been designated by B₃ and of which the depth has been designated by T. At any point of the depression 50, which is elongate in a plan view of the cylinder-head gasket, the depth T of said depression is equal to the difference in level between the lowest point there of the depression 50 and the surface of the carrier layer 16 on either side of the depression (in cross-section through the carrier layer). As already mentioned, the depth T can vary along the depression 50 and in preferred embodiments changes so that the depression 50 is greatest in the vicinity of a screw hole 26 and decreases, in particular continuously, with increasing distance from the screw hole, more specifically potentially to zero. Here, the depression 50 serves to reduce the effective bead height and therefore the bead force exerted by the half-bead 34 as the cylinder-head gasket is installed and during engine operation.

When the cylinder-head gasket is still in the unpressed state, the first bead foot 40 of the half-bead 34 can lie above the deepest point and in particular above the longitudinal center of the depression 50 (in a plan view of the cylinder-head gasket), but more specifically it is preferred, at any point of the half-bead 34 or the depression 50, to configure the cylinder-head gasket so that the first bead foot 40, when the cylinder-head gasket is not yet pressed, lies adjacent to this lowest point and is only displaced against the lowest point as the seal is installed—as the half-bead 34 is flattened during the installation of the seal, the two bead feet 40 and 42 are displaced relative to one another parallel to the carrier layer 16 and transversely to the longitudinal extent of the half-bead 34, which potentially (depending on the design of the cylinder-head gasket) can also cause the first bead foot 40 to be displaced adjacently to the lowest point of the depression 50 during the installation of the seal. Since in particular a reduction of the bead forces in the regions of the seal plate close to the screws is important with regard to the desired flat pressing of the sealing system in the regions of the cylinder-head screws, embodiments are thus preferred in which the first bead foot 40, once the cylinder-head screws have been tightened, bears against the carrier layer 16 at the lowest point of the depression 50, at least in the regions close to the screws.

If the height H₂ of the half-bead 34 lies in the aforementioned range, there is recommended for the dimension T of the depression 50 a range of approximately 10 to approximately 50 μm, preferably a value of approximately 10 to 20 μm, —this is true for a depression 50 having the same maximum depth everywhere, whereas in embodiments in which the depth of the depression 50 varies along the depression, the above-mentioned values are applicable only for the regions of the depression 50 close to the screws.

That which has been stated above for the half-bead 34 and the depression 50 preferably also applies for the half-bead 36 and a depression in the carrier layer 16 associated with said half-bead in accordance with the invention and corresponding to the depression 50.

Before FIG. 4 is discussed, we will now first describe that which can be deduced from FIG. 5, in which the same reference signs as used in FIG. 3 have been used, where possible:

As already mentioned, the depressions 50 are preferably impressed in the carrier layer 16, which in FIG. 5 is illustrated with solid lines still in the undeformed state, i.e. before the impression of the depressions 50. As each of these depressions 50 is impressed, material of the carrier layer 16 is displaced on both sides (in accordance with the cross-sectional illustration shown in FIG. 5) and thus forms, with an appropriate design of the embossing tool, a bulge 60 extending in the longitudinal direction of the depression on each of the two sides of the depression 50 in question, wherein, at any point of the depression 50, the sum of the material volumes of the two bulges 60 is at least approximately equal to the cavity volume of the depression 50 at this point. FIG. 5 shows, with dashed lines, the cross-sectional shape of the carrier layer 16 following the impression of the depressions 50 and the formation of the bulges 60.

FIG. 4 shows parts of a cylinder head 62 and of an engine block 64 and of the functional layers 12, 14 and of the carrier layer 16, wherein, on the right, the half-beads 34 and depressions 50 and bulges 60 associated therewith are illustrated. To the left, FIG. 4 shows the half-beads 36 formed in the two functional layers 12 and 14 and also depressions 50′ and bulges 60′ of the carrier layer 16 associated with said half-beads, for which the same applies as for the depressions 50 and the bulges 60. In FIG. 4 the first bead feet of the half-beads 36 have been designated by 40′, and the second bead feet have been designated by 42′.

Since FIGS. 4 and 5 illustrate the cylinder-head gasket in the as yet non-pressed state, it can also be inferred from FIGS. 4 and 5 that, in this state, the first bead feet 40 and 40′ are offset laterally somewhat compared with the lowest points of the depressions 50 and 50′ (in a plan view of the cylinder-head gasket). In addition, it should be noted that, in FIGS. 4 and 5, the depths of the depressions 50 and 50′ and also the height or thickness of the bulges 60 and 60′ have been illustrated larger than would actually be the case.

FIG. 6A shows substantially the same as FIG. 4, but additionally part of a combustion chamber 180 belonging to the combustion-chamber opening 18 of the cylinder-head gasket, the axis 180a of said combustion chamber having been indicated by a dot-and-dash line, and also a cylinder-head screw 80, which passes through a screw hole 26 in the seal plate 10, and a known deformation-limiting device, which is associated with the combustion-chamber-sealing bead 32 and is formed by combustion-chamber stoppers 182 in the form of flat sheet-metal rings, which annularly surround the combustion-chamber opening and have been fastened to the functional layers 12 and 14 for example by spot welding and have such a thickness that, as the cylinder-head gasket is installed and during engine operation, they allow a certain resilient and therefore reversible flattening of the combustion-chamber-sealing beads 32, but prevent excessive deformation thereof. FIG. 6A shows the cylinder head 62, the engine block 64, and the seal plate 10 prior to the tightening of the cylinder-head screws, that is to say prior to the clamping of the cylinder-head gasket between the cylinder head and engine block; in this state the underside of the cylinder head 22 adjacent to the seal plate 10, that is to say the sealing face of said cylinder head, is not absolutely flat.

As the cylinder-head screws engaging in threaded bores in the engine block 64, and therefore also the cylinder head screw 80, are tightened, these draw the cylinder head 62 according to FIG. 6A downwardly and exert forces onto the engine components and the cylinder-head gasket acting in the direction of the arrow F illustrated in FIG. 6A, which forces cause the functional layers 12, 14 together with the combustion-chamber stoppers 182 and the carrier layer 16 between the cylinder head 62 and the engine block 64 to be clamped en bloc around the combustion-chamber openings 18, that is to say, around the combustion-chamber opening 18, all of these adjacent elements of the cylinder-head gasket bear against one another and also against the cylinder head 62 and the engine block 64. However, as the cylinder-head screws are tightened, the functional layers 12 and 14 are initially placed against the cylinder head 62 and the engine block 64 only at some regions, these regions having been indicated in FIG. 6A for the functional layer 12 by arrows f. Since the regions of the functional layers 12, 14 disposed radially outside the combustion-chamber stoppers 182 relative to the combustion chamber 180 are flexible and, above all, the cylinder head 62 does not constitute an absolutely rigid component, but the screw forces generated by the cylinder-head screws are introduced into the sealing system only locally and radially outside the combustion-chamber stoppers 182, the width (measured vertically according to FIG. 6A) of the seal gap 90, which exists between the cylinder head 62 and the engine block 64 and is to be sealed by the cylinder-head gasket, in the region of the combustion-chamber stoppers 182, is determined, following the proper tightening of the cylinder-head screws, by the sum of the material thicknesses of the functional layers 12, 14, the combustion-chamber stoppers 182 and the carrier layer 16, but the cylinder head 62, which is not absolutely rigid, is drawn downwardly in regions to differing extents radially outside the combustion-chamber stoppers 182 (relative to the combustion chamber 180), and in doing so is deformed differently in regions (cylinder-head distortions); these deformations, however, counteract the springback forces of the resilient fluid-sealing beads, i.e. of the half-beads 34 and 35. In particular when the cylinder-head gasket does not have any backland stoppers or only backland stoppers having a short effective height, the illustrated preferred embodiment of the cylinder-head gasket according to the invention with its depressions 50 and 50′, at least in its regions directly adjacent to the screw holes 26, leads to such a reduction of the effective springback forces of the fluid-sealing beads, i.e. of the half-beads 34 and 36, that the seal plate 10 can also be pressed at least practically completely flat between the cylinder head 62 and the engine block 64 around those screw holes 26 in the direct vicinity of which one or more fluid-sealing bead(s) extends/extend, and at least largely no gaps are present there between the seal plate 10 and the cylinder head 62 and also the engine block 64.

FIG. 6B shows substantially the same parts of the sealing system as FIG. 6A, however the region of the seal plate 10 containing the combustion-chamber stoppers 182 and directly bordering the combustion chamber 180 has been omitted; in FIG. 6B the same reference signs as in FIG. 6A have therefore been used. FIG. 6B, however, qualitatively depicts the state of the sealing system following the proper tightening of all cylinder-head screws.

In FIG. 6B, those points at which the bead feet of the half-beads 34 and 36 bear against the engine components constituted by the cylinder head 62 and engine block 64 or against the carrier layer 16 have been indicated by arrows indicated with continuous lines, whereas those points at which the functional layers 12, 14 bear outside their bead feet against the cylinder head 62 and the engine block 64 or against the carrier layer 16 have been indicated by arrows indicated with dashed lines.

It can be derived from FIG. 6A and the description above that, in the cylinder-head gasket installed in the engine, the combustion-chamber-sealing beads 32 lie in what is known as a shunt pressure path, since their pressing load is limited by the combustion-chamber stoppers 182.

Analogously, it can be derived from FIG. 6B that this is also true, in preferred embodiments of the cylinder-head gasket according to the invention, for the fluid-sealing beads, i.e. the half-beads 34 and 36, more specifically on account of the functional layer 12 or the functional layer 14 in the vicinity of their bulges 60 and 60′ engaging in the depressions 50 and 50′ and supporting bead feet, which bulges have a certain deformation-limiting function or stopper function for these half-beads, i.e. counteract an excessive flattening of these half-beads. It is thus a particular feature of preferred embodiments of the cylinder-head gasket according to the invention that the at least one fluid-sealing bead lies in a shunt pressure path when the cylinder-head gasket is installed.

Although the bead feet 40 and 42 and also 40′ and 42′ of the half-beads 34 and 36 can also be seen from the plan view of the seal plate 10 depicted in FIG. 1, as well as the contours of the depressions 50 and 50′, FIG. 2 is much clearer in this respect, and therefore the corresponding reference signs have been provided only in FIG. 2.

FIG. 2 shows, by means of a solid line, the course of the bead foot 42 and, by means of dashed lines, the course of the lateral edges 50a and 50b of the depression 50 belonging to the bead foot 42, and in addition shows, by means of a continuous line, the course of the bead foot 42 and also, by means of dashed lines, the course of the lateral edges 50a′ and 50b′ of the depression 50′ associated with the bead foot 42′, and lastly, by means of dot-and-dash lines, the courses of the bead feet 40 and 40′.

Lastly, it should also be noted that a plurality of what are known as backland stoppers 100 have been indicated in FIG. 1, which may be comprised optionally by a cylinder-head gasket according to the invention and which can be provided on one or more seal layers of the seal plate 10.

1. A cylinder-head gasket having an elongate, multi-layered, metal seal plate, which comprises a plurality of combustion-chamber openings, fluid-passage openings, and screw holes for the passage of cylinder-head screws, and at least a first functional layer and also a carrier layer, wherein the functional layer is provided with combustion-chamber-sealing beads, which surround the combustion-chamber openings, and, on that side of the combustion-chamber-sealing beads which is directed away from the combustion-chamber openings, at a spacing from said beads, with at least one fluid-sealing bead, which is formed as a half-bead and which also has a first bead foot, which is to be pressed against the carrier layer, and a second bead foot, spaced apart from the first bead foot by the bead width, and wherein the carrier layer has, on its first layer side directed towards the first functional layer, at least in some regions of the seal plate adjacent to screw holes, at least one elongate and shallow depression extending along the first bead foot, said depression being of such a width that there lies over the depression only a strip-like region of the first functional layer which contains only the first bead foot of the half-bead and at most half the bead width, but not the second bead foot.

2. The cylinder-head gasket according to claim 1, wherein the depression extends over the entire length of the first bead foot.

3. The cylinder-head gasket according to claim 1, wherein, in a plan view of the seal plate, the first bead foot lies above a longitudinal central region of the depression.

4. The cylinder-head gasket according to claim 1, wherein the depth of the region of the depression opposite the first bead foot, averaged along the depression, is approximately equal to 4 to 30%, preferably equal to 10 to 25% of the height of the unpressed half-bead.

5. The cylinder-head gasket according to claim 1, wherein the height of the unpressed half-bead is 150 to 250 μm, preferably 180 to 220 μm.

6. The cylinder-head gasket according to claim 1, wherein the depth of the region of the depression opposite the first bead foot, averaged along the depression, is approximately 10 to preferably 10 to 35 μm.

7. The cylinder-head gasket according to claim 1, wherein the depression is an impression in the carrier layer.

8. The cylinder-head gasket according to claim 7, wherein the carrier layer, on its first layer side directed towards the first functional layer, on both sides of said depression, has a bulge extending along the depression which bulge protrudes over the first layer side.

9. The cylinder-head gasket according to claim 1, wherein the carrier layer is mono-layered, at least in a first region opposite the half-bead.

10. The cylinder-head gasket according to claim 1, wherein the carrier layer, at least in a first region opposite the half-bead, has a greater average material thickness than the strip-shaped region of the functional layer.

11. The cylinder-head gasket according to claim 1, wherein the half-bead is directly adjacent to the carrier layer.

12. The cylinder-head gasket according to claim 1, wherein the seal plate comprises a second functional layer, the carrier layer is arranged between the first and second functional layer, and the seal plate, at least in the region of the half-bead, is at least substantially mirror-symmetrical with respect to a central plane extending in the carrier layer.

13. The cylinder-head gasket according to claim 1, wherein the depression along the first bead foot has a depth that changes in such a way that portions of the depression adjacent to screw holes have a greater depth than portions of the depression adjacent to seal plate regions disposed between adjacent screw holes.

14. The cylinder-head gasket according to claim 1, wherein the seal plate is constructed in such a way that, when the cylinder-head gasket is installed, the carrier layer and the at least one functional layer are clamped en bloc in the screw hole regions.

15. The cylinder-head gasket according to claim 1, wherein the seal plate comprises deformation limiters associated with the combustion-chamber-sealing beads, in particular between the latter and the combustion-chamber openings, and also cylinder-head-supporting elements arranged in longitudinal end regions of the seal plate, and is constructed in such a way that, when the cylinder-head gasket is installed, the elements of the seal plate in the regions of the deformation limiters and the supporting elements are clamped en bloc.

16. The cylinder-head gasket according to claim 1, wherein the depression has a cross-section in the shape of a rounded shallow trough.

17. A sealing system, comprising at least one cylinder head, an engine block, cylinder-head screws, and, clamped between the cylinder head and engine block, a cylinder-head gasket according to claim 1.

18. The sealing system according to claim 17, wherein the depth of the at least one depression is matched to the half-bead and the rigidities and also the temperature expansion coefficients of the cylinder head, engine block and cylinder-head screws in such a way that the half-bead, as the cylinder-head gasket is clamped, is not excessively flattened in the sense of the durability of the half-bead, and the bead feet of the half-bead are pressed all over in strip-like bearing regions by means of a force sufficient for the sealing capability of said half-bead, against the carrier layer and the cylinder head or the engine block.
